(19) United States
(12) Patent Application Publication
(10) Pub. No.: US 2018/0224575 A1
(43) Pub. Date: Aug. 9, 2018

(54) OPHTHALMIC LENS AND ASSOCIATE PRODUCTION METHOD

(71) Applicant: ESSILOR INTERNATIONAL, Charenton-le Pont (FR)

(72) Inventors: Christelle MARCK, Charenton-le-Pont (FR); Abigaëlle CABARET, Charenton-le-Pont (FR)

(21) Appl. No.: 15/748,067

(22) PCT Filed: Jul. 27, 2016
(86) PCT No.: PCT/FR2016/051945

§ 371 Date: Jan. 26, 2018

(30) Foreign Application Priority Data
Jul. 28, 2015 (FR) 1557201

(51) Int. Cl. G02B 1/00; G02B 1/04; G02B 5/28

(52) U.S. Cl. CPC G02B 1/005; G02B 5/28; G02B 1/043

(57) ABSTRACT

The invention concerns an ophthalmic lens (1) that comprises a substrate (2) having a front main face (3) and a rear main face (4) and a photonic crystal layer (5) at least partially covering one of said main faces, and that has a spectral reflectivity curve for an incident angle on the front main face of between 0° and 45°, having a reflectivity peak with a maximum reflectivity value at a peak wavelength of between 420 and 450 nanometers, and a chroma value on reflection by the front main face with an incident angle of between 0° and 45° that is less than 30. The invention also concerns a method for producing such an ophthalmic lens.

### TECHNICAL FIELD OF THE INVENTION

The invention generally relates to the field of ophthalmic optics. More particularly, it relates to an ophthalmic lens designed to reduce the effects of the phototoxicity of blue light on the retina of a spectacle wearer. It also relates to a process for manufacturing such an ophthalmic lens.

### BACKGROUND OF THE INVENTION

The light visible by the human eye extends over a light spectrum extending from a wavelength of 380 nanometers (nm) to 780 nm or thereabouts. That portion of this spectrum which is located between about 380 nm and 500 nm corresponds to substantially blue high-energy light.

Many studies (see Kitchel E., “The effects of blue light on ocular health”, Journal of Visual Impairment and Blindness Vol. 94, No. 6, 2000 or Glazer-Hockstein et al., Retina, Vol. 26, No. 1, pp. 1-4, 2006) suggest that blue light has phototoxic effects on the eye, and in particular on the retina.

Specifically, studies of ocular photobiology (Algvere P. V. et al., “Age-Related Maculopathy and the Impact of the Blue Light Hazard”, Acta Ophthalmo. Scand., Vol. 84, pp. 4-15, 2006) and clinical studies (Tomany S. C. et al., “Sunlight and the 10-Year Incidence of Age-Related Maculopathy. The Beaver Dam Eye Study”, Arch Ophthalmol., Vol. 122, pp. 750-757, 2004) have shown that exposure to blue light for too long or that is too intense may induce severe ophthalmic pathologies such as age-related macular degeneration (AMD).

Nevertheless, a portion of this blue light, comprised between about 465 nm and 495 nm is beneficial insofar as it plays a role in mechanisms for regulating biological rhythms, called “circadian cycles”.

Thus, it is recommended to limit exposure to potentially harmful blue light, in particular for the wavelength band that is known to be particularly hazardous (see in particular table B1 of standard ISO 8980-3:2003 (E) regarding the hazard function of blue light).

For this reason, it may be advised to wear in front of each of the eyes an ophthalmic lens that prevents or limits transmission of phototoxic blue light as far as the retina.

Thus, an ophthalmic lens including a substrate having a front main face and a back main face, and a selective interference filter, for example a photonic crystal layer, has been proposed in document WO 2013/084177.

The ophthalmic lenses of document WO 2013/084177 reflect phototoxic blue light over a wide range of wavelengths for example extending from 395 nm to 465 nm. The reflection of ambient light from the front main face of the substrate of the lens may then result in a notably bluish reflection.

In certain cases, this aesthetic defect may lead the wearer to reject such ophthalmic lenses.

It would therefore be desirable to propose ophthalmic lenses allowing the transmission of blue light to be attenuated without creating unattractive reflections.

### SUMMARY OF THE INVENTION

In order to remedy the aforementioned drawback of the prior art, the present invention provides an ophthalmic lens allowing not only the amount of phototoxic blue light reaching the retina of the wearer to be limited, but also the residual hue in reflection of such an ophthalmic lens to be attenuated.

More particularly, according to the invention an ophthalmic lens including:
a substrate having a front main face and a back main face, and
a photonic crystal layer at least partially covering one of said main faces of the substrate is proposed, said ophthalmic lens having:
a curve of spectral reflectance for an angle of incidence on said front main face comprised between 0° and 45° that comprises a reflectivity peak having a maximum reflectivity value at a peak wavelength comprised between 420 and 450 nanometers, and
a chroma value in reflection from said front main face with an angle of incidence comprised between 0° and 45° that is lower than 30.

By virtue of the chroma value in reflection that is limited to 30, the residual light in reflection of the ophthalmic lens of the invention is of low intensity, so that an observer of the wearer of this ophthalmic lens does not perceive or hardly perceives the blueishness of the reflection from the front main face of the substrate.

In addition, the wearer of this lens is correctly protected from the phototoxic effects of blue light comprised between 440 and 460 nm by virtue of the reflectivity peak that is maximum in this wavelength range.

The following are other nonlimiting and advantageous features of the ophthalmic lens according to the invention, which may be implemented individually or in any technically possible combination:
the ophthalmic lens has, in transmission through said ophthalmic lens with an angle of incidence comprised between 0° and 45°, a yellowness index lower than 30;
said maximum reflectivity value is higher than 15%;
said reflectivity peak has a full width at half maximum smaller than 80 nanometers;
said chroma value is lower than 20;
said ophthalmic lens has, for an angle of incidence comprised between 0° and 45°, a mean transmittance in the blue, in a wavelength range extending from 420 to 450 nanometers, lower than 80%;
said ophthalmic lens has a mean luminous transmittance higher than 92%;
said ophthalmic lens has a mean luminous reflectance lower than 2.5%;
said photonic crystal layer is formed from a matrix and from colloidal particles arranged in said matrix;
said photonic crystal layer has a thickness comprised between 1 and 40 microns and preferably between 3 and 30 microns;
said photonic crystal layer has a spectral reflectance curve for an angle of incidence comprised between 0° and 45° that comprises a reflectivity peak having a maximum reflectivity value at a wavelength comprised between 420 and 450 nm, and a chroma value in reflection from said layer with an angle of incidence comprised between 0° and 45° that is lower than 30.

The photonic crystal layer may be deposited in various ways on the substrate of the ophthalmic lens.

Thus, the invention proposes a process for manufacturing an ophthalmic lens according to the invention.

According to a first aspect, the manufacturing process includes the following steps:

a) depositing on a plastic film an initial layer of a solution containing a solvent and a composition containing colloidal particles in suspension in a matrix;

b) at least partially evaporating the solvent from the initial layer deposited on said plastic film so that the colloidal particles arrange themselves in said matrix to form an intermediate photonic crystal layer on said plastic film;

c) solidifying the matrix of said intermediate layer on said plastic film in order to form a photonic crystal layer on said plastic film; and

d) applying said plastic film to said ophthalmic lens so as to secure said photonic crystal layer to at least one of the front and back main faces of a substrate of the ophthalmic lens.

According to the invention, the composition implemented in step a) of the process is such that the ophthalmic lens has:
a curve of spectral reflectance for an angle of incidence on said front main face comprised between 0° and 45° that comprises a reflectivity peak having a maximum reflectivity value at a peak wavelength comprised between 420 and 450 nanometers, and
a chroma value in reflection from said front main face with an angle of incidence comprised between 0° and 45° that is lower than 30.

According to a second aspect, the manufacturing process includes the following steps:

a′) depositing an initial layer of a solution containing a solvent and a composition containing colloidal particles in suspension in a matrix on at least one of the front and back main faces of a substrate of the ophthalmic lens;

b′) at least partially evaporating the solvent from the initial layer deposited on said main face so that the colloidal particles arrange themselves in said matrix to form an intermediate photonic crystal layer; and

c′) solidifying the matrix of the intermediate layer.

According to the invention, the composition implemented in step a) is such that the ophthalmic lens has:
a curve of spectral reflectance for an angle of incidence on said front main face comprised between 0° and 45° that comprises a reflectivity peak having a maximum reflectivity value at a peak wavelength comprised between 420 and 450 nanometers, and
a chroma value in reflection from said front main face with an angle of incidence comprised between 0° and 45° that is lower than 30.

### DETAILED DESCRIPTION OF ONE EXEMPLARY EMBODIMENT

The following description, which refers to the appended drawings, which are given by way of nonlimiting example, will allow the invention and how it may be carried out to be understood.

In the appended drawings:

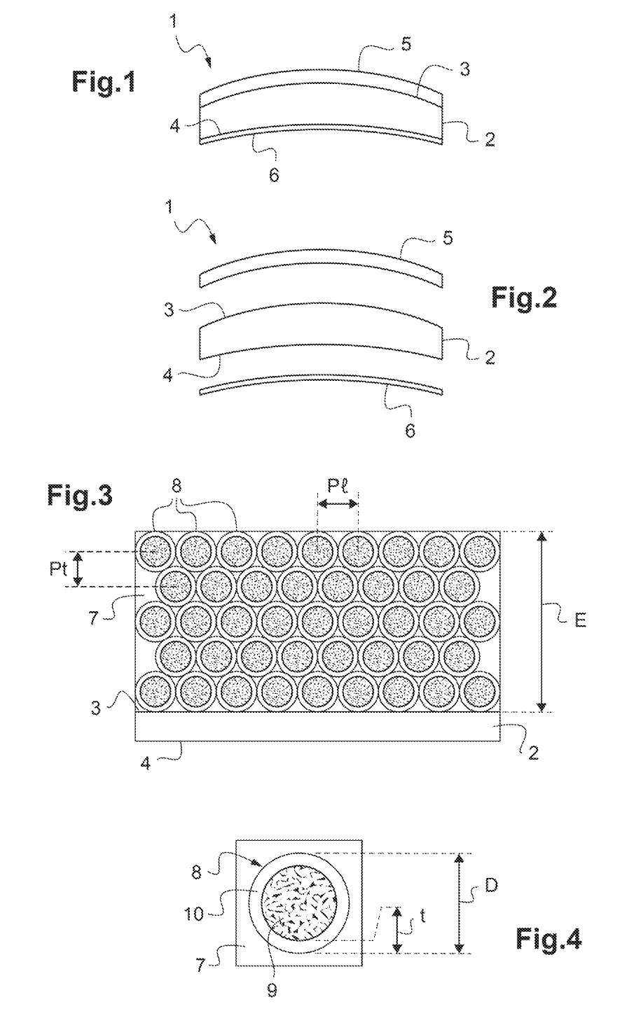

FIG. 1 is a schematic view of an ophthalmic lens according to invention including a photonic crystal layer on its front face and an antireflection treatment on its back face;

FIG. 2 is an exploded view of the ophthalmic lens in FIG. 1;

FIG. 3 is a detailed view of the ophthalmic lens in FIG. 1 showing the structure of the photonic crystal layer;

FIG. 4 is a schematic view of a core-shell type colloidal particle forming part of the composition of the photonic crystal layer in FIG. 3;

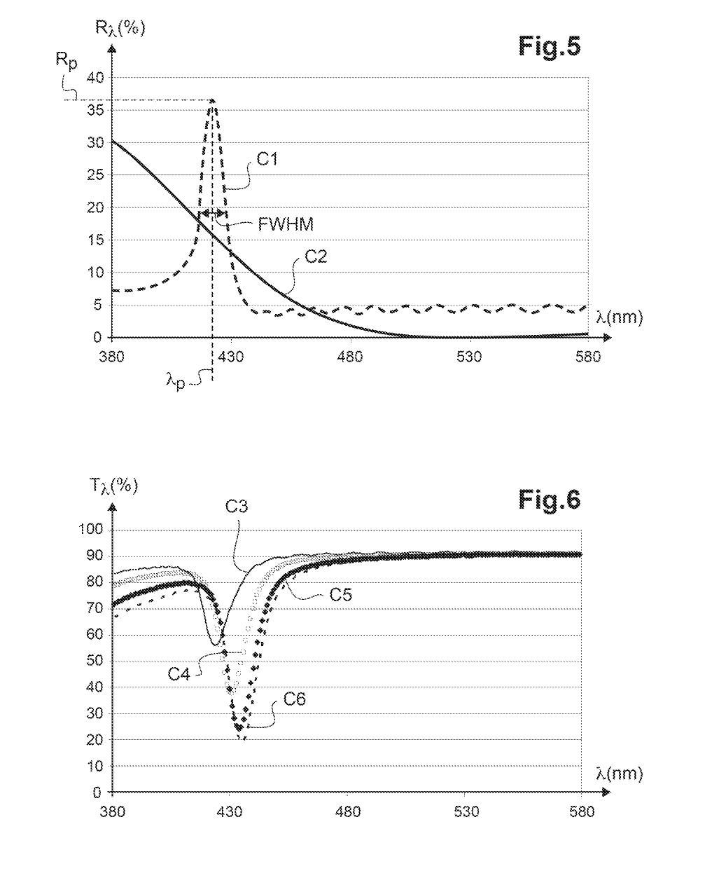

FIG. 5 shows the spectral reflectance curves of a prior-art ophthalmic lens and of an ophthalmic lens according to the invention; and

FIG. 6 shows the spectral transmission curves of an ophthalmic lens according to the invention for various thicknesses of the photonic crystal layer.

Throughout the present patent application, reference will be made to ranges of values, in particular of wavelengths and angles of incidence. The expression “comprised between the values x and y” is understood to mean “in the range from x to y”, the limits x and y being included in this range.

In a conventional way, and as shown in FIGS. 1 and 2, the ophthalmic lens 1 according to the invention comprises a transparent substrate 2 made of organic or mineral glass. This substrate may comprise one or more functional coatings in order to confer on the ophthalmic lens particular optical and/or mechanical properties such as, for example, an anti-shock coating, an anti-abrasion coating, a nonstick coating, a barrier coating, an anti-reflection coating, an anti-UV coating, an anti-static coating, a polarizing coating, a tinting coating and an anti-smear and/or an anti-fog coating.

The substrate 2 of the ophthalmic lens 1 is preferably made of organic glass, for example of a thermoplastic or thermoset.

Regarding thermoplastics suitable for the substrates, mention may be made of (meth)acrylic (co)polymers, in particular polymethyl methacrylate (PMMA), thio(meth)acrylic (co)polymers, polyvinyl butyral (PVB), polycarbonates (PC), polyurethanes (PU), polythiourethanes, polyol(allyl carbonate) (co)polymers, thermoplastic ethylene/vinyl acetate copolymers, polyesters such as polyethylene terephthalate (PET) or polybutylene terephthalate (PBT), polyepisulfides, polyepoxides, polycarbonate/polyester copolymers, cyclic olefin copolymers such as ethylene/norbornene or ethylene/cyclopentadiene copolymers and their blends.

The term “(co)polymer” is understood to mean a copolymer or a homopolymer. The term “(meth)acrylate” is understood to mean an acrylate or a methacrylate. The term “polycarbonate (PC)” is understood in the context of the present invention to mean both homopolycarbonates and copolycarbonates and sequenced copolycarbonates.

Substrates obtained by (co)polymerization of the diethylene glycol bis(allyl carbonate) sold, for example, under the tradename CR-39® by PPG Industries (ESSILOR ORMA® lenses), or the polythiourethane/polysulfide substrates obtained for example by polymerization of the products sold under the tradenames MR6, MR7, MR8, MR10 and MR1.74 by MITSUI are the particularly recommended substrates.

Other recommended substrates are the polycarbonates.

As FIGS. 1 and 2 show, the substrate 2 of the ophthalmic lens 1 has a front main face 3 and a back main face 4.

By back main face what is meant is the main face that, when the ophthalmic lens is being used, is closest to the eye of the user. This is generally a concave face. In contrast, by front main face what is meant is the main face that, when the ophthalmic lens is being used, is furthest from the eye of the user. This is generally a convex face.

As indicated above, the substrate 2 of the ophthalmic lens 1 may comprise various coatings either on the front main face 3 of the ophthalmic lens 1 or on the back main face 4 of the ophthalmic lens 1.

When the substrate includes no coatings, a bare substrate is spoken of.

A coating that is “on” the substrate or that has been deposited “on” the substrate is defined as a coating that:

is positioned above one main face 3, 4 of the substrate 2;
(ii) does not necessarily make contact with the substrate 2, i.e. one or more intermediate coatings may be placed between the substrate 2 and the coating in question; and
(iii) does not necessarily completely cover the main face of the substrate 2 on which it is deposited.

When “a layer A is said to be located under a layer B”, it will be understood that the layer B is further from the substrate than the layer A.

According to the invention, the ophthalmic lens 1 includes a photonic crystal layer 5 at least partially covering one of the main faces of the substrate 2, here the front main face 3 (see FIGS. 1 and 2).

In the particular embodiment described here, the photonic crystal layer 5 completely covers the front main face 3 of the ophthalmic lens 1, i.e. more than 99% of this surface of the main face.

In another embodiment, the photonic crystal layer may cover almost all of one of the main faces of the substrate. It may for example cover at least 90%, or even more than 95% of the entire surface of the main face on which it is deposited.

In other embodiments, the photonic crystal layer may cover a smaller portion of one of the main faces of the substrate, for example less than 70%, or even less than 50% of the entire surface of the main face on which it is deposited.

In certain embodiments, the ophthalmic lens may include two photonic crystal layers, which may be identical or different: a first photonic crystal layer on the front main face and a second photonic crystal layer on the back main face. The first photonic crystal layer and the second photonic crystal layer may then cover all or some of the front main face and the back main face, respectively.

In other embodiments, the ophthalmic lens includes two photonic crystal layers, which may be identical or different, deposited on the same main face of the substrate: a first photonic crystal layer deposited on this main face and a second photonic crystal layer deposited on this first layer.

In yet other embodiments, the ophthalmic lens includes a first and a second photonic crystal layer, which may be identical or different, deposited on the same main face of the substrate, these two layers being adjacent and each partially covering this main face. For example, the first layer may cover a first zone of the surface of the main face and the second layer may cover a second zone of the surface of the main face.

In one recommended embodiment, the photonic crystal layer 5 is deposited directly on the main face of the bare substrate 2 of the ophthalmic lens 1, here the front main face 3.

It is conventional, before the photonic crystal layer 5 is deposited, to subject the surface of the substrate 2 to a physical or chemical activation treatment intended to increase the adhesion of the photonic crystal layer 5 to the main face(s).

This pre-treatment may be carried out under vacuum. It may be a question of a bombardment with energetic species, for example an ion beam (ion pre-cleaning or IPC) or an electron beam, a corona discharge treatment, a glow discharge treatment, a UV treatment or treatment in a vacuum plasma, generally an oxygen or argon plasma. It may also be a question of an acidic or basic surface treatment and/or a treatment with solvents (water or organic solvent).

The photonic crystal layer 5 deposited on the front main face 3 of the substrate 2 of the ophthalmic lens 1 confers thereon properties of optical filtration of light.

The filtration of light by means of a photonic crystal is based on the principle of Bragg gratings, the periodic structure of which reflects, via constructive interferences, incident light at one or a plurality of wavelengths, or even in a wavelength band.

The one or more periodicities of the structure of the photonic crystal are of the same order of magnitude as the one or more wavelengths that it is desired to reflect.

According to one particularly advantageous aspect of the invention, as shown in FIG. 3, the photonic crystal layer 5 here includes a matrix 7 and a set of colloidal particles 8 that are arranged in this matrix 7.

Alternatively, the photonic crystal layer may be formed from a matrix containing an arrangement of cavities, holes for example.

The colloidal particles 8 are organized in the matrix 7 in an ordered three-dimensional lattice, in general of face-centered cubic or compact hexagonal type (case of FIG. 3).

The volume fraction fᵥ of particles in the matrix is defined as being the ratio, per unit of volume of the photonic crystal layer 5, between the volume occupied by the colloidal particles 8 and the volume occupied by the matrix 7. Typically, the volume fraction fᵥ may be comprised between 30 and 70%.

In the particular embodiment shown in FIG. 3, the lattice of colloidal particles 8 in the matrix 7 of the photonic crystal layer 5 is organized periodically, with a longitudinal periodicity Pl (in a plane parallel to the substrate 2) and a transverse periodicity Pt (perpendicularly to the substrate 2).

The matrix 7 may be a mineral matrix or indeed an organic matrix, a polymer matrix for example.

The colloidal particles 8 may be mineral particles or indeed organic particles. Generally, the colloidal particles 8 are on the whole of spherical or ellipsoidal shape.

Preferably, the matrix 7 is a polymer matrix and the colloidal particles 8 are organic particles (case in FIG. 3). The polymer matrix 7 and the colloidal particles 8 may be made of a (meth)acrylic resin, of a polyester resin, of a polycarbonate resin, of a polyamide resin, of a urethane resin, of a polyvinyl resin, of a polyolefin resin, of a melamine resin or of a blend of these resins. (Meth)acrylic, polyester and polyolefin resins are recommended.

Conventionally, the photonic crystal is obtained by self-assembly (“self-organization” is also spoken of) of the organic colloidal particles 8 in the polymer matrix 7.

Documents US 2013/017 1438 and EP 258 6799 describe how to obtain such photonic crystal layers by self-organization.

In the particular embodiment described here and illustrated in FIG. 4, the colloidal particles 8 are “core-shell” type particles, each comprising a core 9 of spherical shape and a shell 10 surrounding the entirety of the core 9.

The core and shell may be made of a (meth)acrylic resin, of a polyester resin, of a polycarbonate resin, of a polyamide resin, of a urethane resin, of a polyvinyl resin, of a polyolefin resin, of a melamine resin or of a blend of these resins. Colloidal particles, the core of which is made of acrylic resin and the shell of which is made of polyvinyl resin, are recommended.

Each colloidal particle 8 has a diameter D (see FIG. 4). The shell 10 of each colloidal particle 8 has a shell thickness t (see FIG. 4) and a shell refractive index nₛₕ; the core 9 has a core diameter equal to D-t and a core refractive index n_{co}.

The matrix 7 has, for its part, a matrix refractive index nₘₐₜ.

In light of FIG. 3, it will be understood that the total thickness E of the photonic crystal layer 5 depends on the number of sublayers of colloidal particles 8 stacked on top of one another to form said layer and the spacing between each sublayer.

Typically, the photonic crystal layer 5 comprises between 10 and 150 sublayers of colloidal particles 8, the latter having a diameter D comprised between 100 and 500 nm.

Preferably, the photonic crystal layer 5 has a total thickness E comprised between 1 and 40 microns and better still between 3 and 30 microns.

With a thickness larger than 5 microns and smaller than 25 microns it is possible to obtain a satisfactory compromise between the intensity of the luminous reflection and the effectiveness of the filter formed by the photonic crystal layer 5 to limit the transmission of phototoxic blue light in the wavelength range of 420 to 450 nm.

In one particular embodiment, a dye is added to the photonic crystal layer. This dye may be a pigment dispersed in the matrix or a dye that is soluble in the matrix. The dye is generally added to the solution containing a solvent and a composition containing colloidal particles in suspension in a matrix, before its deposition on a substrate or a film. The dye may also be added to the matrix or to the solvent before the solution containing a solvent and a composition containing colloidal particles in suspension in a matrix is prepared.

The added dye does not modify the characteristics of the light reflected by the photonic crystal layer, but may modulate the characteristics of the transmitted color. Thus, for the ophthalmic lens wearer, the added dye modifies the color of the glass in order to decrease the residual yellow hue, which is not very attractive, or in order to dye it according to the desires of the wearer.

In the present application, the spectral reflectance, denoted R_{λ}, of the ophthalmic lens 1, for a given angle of incidence on the front main face 3 of the substrate 2, is the variation in the reflectivity (i.e. of the energy reflectance) at this angle of incidence as a function of the wavelength λ of the incident light.

The spectral reflectance curve corresponds to a graphical representation of the spectral reflectance R_{λ}, in which the spectral reflectance (ordinate) is drawn as a function of the wavelength λ (abscissa).

Curves of spectral reflectance may be measured by means of a spectrophotometer, for example a Perkin Elmer Lambda 850 spectrophotometer equipped with a URA (universal reflectance accessory).

The mean transmittance in the blue, denoted T_{m,B} below, is defined as being the (unweighted) mean of the spectral transmittance in the wavelength range extending from 420 nm to 450 nm, corresponding to phototoxic blue light (at an angle of incidence smaller than 17° and typically of 0°).

The visual transmittance, denoted Tᵥ, also referred to in the present patent application as the mean luminous transmittance, is such that as defined in standard ISO 13666:1998, and measured according to standard ISO 8980-3 (at an angle of incidence smaller than 17° and typically of 0°).

Likewise, the visual reflectance, denoted Rᵥ, also referred to in the present patent application as mean luminous reflectance, is such as defined in standard ISO 13666:1998 and measured according to standard ISO 8980-4 (at an angle of incidence smaller than 17° and typically 15°), i.e. it is a question of the weighted mean of the spectral reflectance R_{A} over all of the visible light spectrum comprised between 380 nm and 780 nm.

Lastly, chroma, also called “chromaticity” and denoted C below is such as defined by the CIE Lab 76 model.

In the present application, the chroma value C measured or calculated in reflection from the front main face 3 of the substrate 2 with an angle of incidence on this front main face comprised between 0° (normal incidence) and 45° (oblique incidence), under standard illuminant D65 and by a standard observer (angle of 10°) will in particular be considered.

According to the invention, the ophthalmic lens 1 has:
a curve of spectral reflectance R_{A} for an angle of incidence on the front main face 3 comprised between 0° and 45° that comprises a reflectivity peak having a maximum reflectivity value at a peak wavelength comprised between 400 and 460 nanometers, and
a chroma value C in reflection from the front main face 3 with an angle of incidence comprised between 0° and 45° that is lower than 30.

Advantageously, the maximum reflectivity value, denoted Rₚ, of the peak is obtained for a peak wavelength, denoted λₚ, that is comprised between 410 and 450 nm and better still between 420 and 450 nm.

This allows blue wavelengths, the phototoxic effect of which is greater, to be more effectively rejected.

In one particular embodiment, the ophthalmic lens 1 has a curve of spectral reflectance R_{A} such that the maximum reflectivity value Rₚ is higher than 15%, preferably higher than 20% and even more preferably higher than 30%.

Advantageously, the reflectivity peak has a full width at half maximum (FWHM) that is smaller than 80 nanometers, preferably smaller than 50 nanometers and even more preferably smaller than 30 nm.

Also advantageously, the chroma value C in reflection is lower than 20 and better still lower than 10.

The photonic crystal layer of the ophthalmic lens works as a selective interference filter in reflection for phototoxic blue light.

The mean transmittance in the blue T_{m,B} may be adjusted by modifying the geometric and optical properties of the photonic crystal layer 5.

To this end, it is possible to vary the total thickness E of the photonic crystal layer 5: this allows the levels of luminous transmittance and reflectance, i.e. the maximum reflectivity value Rₚ at the peak wavelength λₚ, to be adjusted.

The total thickness E may be adjusted by varying the number of sublayers of colloidal particles 8 forming the photonic crystal layer 5.

Moreover, the core diameter and refractive index n_{co}, the shell thickness t and the shell refractive index nₛₕ, the matrix refractive index nₘₐₜ, the volume fraction fᵥ of particles in the matrix, or even the longitudinal periodicity Pl and transverse periodicity Pt, may also be set so that the ophthalmic lens 1 has the required optical properties as regards the peak wavelength λₚ of the spectral reflectance peak, spectral reflectance R_{λ} and the chroma C of the reflected light.

In one particular embodiment of the invention, the ophthalmic lens 1 has, in transmission through said ophthalmic lens with an angle of incidence comprised between 0° and 45°, a yellowness index lower than 30, preferably lower than 20 and better still lower than 10.

The yellowness index (YI) in transmission is defined according to standard ASTM D-1925. YI is determined from the tristimulus values, X, Y, Z defined by the CIE, with the relationship: YI=(128*X−106*Z)/Y.

The yellowness index YI expresses the tendency of the ophthalmic lens to transmit light of relatively yellow color.

Particularly advantageously, the ophthalmic lens 1 has, for an angle of incidence comprised between 0° and 45°, a mean transmittance in the blue T_{m,B}, in a wavelength range extending from 420 to 450 nm, lower than 80%, preferably lower than 70% and better still lower than 60%.

In certain embodiments, the ophthalmic lens 1 has a mean luminous transmittance Tᵥ (see the above definition) higher than 90% and better still higher than 95%.

In other embodiments, the ophthalmic lens 1 moreover has a mean luminous reflectance Rᵥ lower than 2.5% and better still lower than 1.5%.

The ophthalmic lens 1 of the invention may include on one or both of the main faces 3, 4 of the substrate 2 a functional layer covering all or some of said main face 3, 4 of the substrate 2.

This functional layer may for example be: an anti-shock layer, an anti-abrasion layer, an adhesive coating, a barrier coating, an antistatic layer, an anti-smudge layer, an antireflection coating, an antifog layer, a tinting layer, a polarizing layer, a photochromic layer, etc.

Thus, in the particular embodiment shown in FIGS. 1 to 4, the ophthalmic lens 1 includes an antireflection coating 6 deposited on the back main face 4 of the substrate 2. The antireflection coating here completely covers the surface of the back main face 4.

Examples of anti-reflection coatings formed by stacking high-index and low-index layers are described in documents WO 2008/107325 and WO 2012/076714.

According to another embodiment, the antireflection coating may be deposited on the photonic crystal layer, whether the latter be deposited on the front main face or on the back main face of the substrate.

In any case, provision may advantageously be made to insert, between the photonic crystal layer and the antireflection coating, an anti-abrasion layer.

It is possible in the ophthalmic lens 1 according to the invention to disassociate the function of selective filtration of phototoxic blue light by virtue of the photonic crystal layer 5 and the antireflection function by virtue of the antireflection coating 6.

The ophthalmic lens thus obtained has performance levels higher than an ophthalmic lens providing antireflection and selective filtration functions by means of one and the same system, for example a stack of thin dielectric layers.

Generally, the photonic crystal layer may be deposited directly on a bare substrate.

With certain substrates, it is preferable for the main face of the ophthalmic lens including the photonic crystal layer to be coated with one or more functional coatings, an adhesive coating and/or a barrier coating for example, before the filter is formed on this main face.

Generally, the front and/or back main face of the substrate on which the photonic crystal layer is deposited is then coated with functional coatings that are conventionally used in optics, possibly being, nonlimitingly: an antishock primer layer, an anti-abrasion and/or anti-scratch coating, a polarizer coating, a colored coating, an antireflection coating.

The ophthalmic lens according to the invention may also comprise coatings, formed on the photonic crystal layer and capable of modifying its surface properties, such as hydrophobic coatings and/or oleophobic coatings (anti-smudge top coat) and/or anti-fog coatings. Such coatings are described, inter alia, in document U.S. Pat. No. 7,678,464. They are generally smaller than or equal to 10 nm in thickness, preferably from 1 to 10 nm in thickness and better still from 1 to 5 nm in thickness.

Typically, an ophthalmic lens according to the invention comprises a substrate coated in succession on its front main face with a photonic crystal layer according to the invention, with an anti-abrasion and/or anti-scratch layer, with an antireflection coating, and with a hydrophobic and/or oleophobic coating.

The back main face of the substrate of the optical article may be coated in succession with an antishock primer layer, with an anti-abrasion and/or anti-scratch layer, with an antireflection coating that may or may not be an anti-UV antireflection coating, and with a hydrophobic and/or oleophobic coating.

The ophthalmic lens according to the invention is preferably an ophthalmic lens for a pair of spectacles, or an ophthalmic lens blank. The ophthalmic lens according to the invention may be corrective or non-corrective. Corrective ophthalmic lenses may be unifocal, bifocal, trifocal or progressive. Thus, the invention also relates to a pair of spectacles comprising at least one such ophthalmic lens.

It is particularly advantageous for protecting the eyes of a wearer from the phototoxicity of blue light.

An ophthalmic lens such as described above also has the advantage of increasing the visual comfort with which the wearer is able to perceive colors.

The ophthalmic lens of the invention, in its variant embodiments described above, may be manufactured using two manufacturing processes that also form part of the invention.

The first manufacturing process is a process in which the photonic crystal layer is added to one of the main faces of the substrate of the ophthalmic lens by means of a plastic film.

According to the invention, this first manufacturing process includes the following steps:

a) depositing on a plastic film an initial layer of a solution containing a solvent and a composition containing colloidal particles in suspension in a matrix;

b) at least partially evaporating the solvent from the initial layer deposited on said plastic film so that the colloidal particles arrange themselves in said matrix to form an intermediate photonic crystal layer on said plastic film;

c) solidifying the matrix of said intermediate layer on said plastic film in order to form a photonic crystal layer on said plastic film; and

d) applying said plastic film to said ophthalmic lens so as to secure said photonic crystal layer to at least one of the front and back main faces of a substrate of the ophthalmic lens.

The second manufacturing process is a process in which the photonic crystal layer is deposited directly (i.e. without use of a plastic film) on one of the main faces of the substrate of the ophthalmic lens.

According to the invention, this second manufacturing process includes the following steps:

a′) depositing an initial layer of a solution containing a solvent and a composition containing colloidal particles in suspension in a matrix on at least one of the front and back main faces of a substrate of the ophthalmic lens;

b′) at least partially evaporating the solvent from the initial layer deposited on said main face so that the colloidal particles arrange themselves in said matrix to form an intermediate photonic crystal layer; and

c′) solidifying the matrix of the intermediate layer.

The following examples illustrate the invention in more detail but nonlimitingly and in particular the various processes for manufacturing an ophthalmic lens according to the invention.

In particular, examples 1 to 4 below relate to ophthalmic lenses manufactured according to the first manufacturing process. Examples 6 to 8 relate to ophthalmic lenses manufactured according to the second manufacturing process.

### EXAMPLES

### 1) Examples 1 to 4—Implementation No. 1: Deposition of the Photonic Crystal Layer by Means of a Plastic Film

In these first examples, the photonic crystal layer is deposited on a thermoplastic film that is itself transferred to the ophthalmic lens by thermoforming.

More precisely, according to one particular embodiment, in a first step of the process (step a), an initial layer of a solution is deposited on a flat plastic film of polyethylene terephthalate (PET) of 80 μm thickness, said solution containing:
a solvent taking the form of glycol acetate; and
a composition such as described in document EP 2586799 and containing:
   an acrylate polymer matrix of refractive index nₘₐₜ=1.6; and
   organic colloidal particles in suspension in the matrix with a volume fraction fᵥ=40%, the colloidal particles being of “core-shelf” type with a core made of acrylic resin of diameter D-t=160 nm and of refractive index n_{co}=1.49, and a shell made of polystyrene of thickness t=70 nm and of refractive index nₛₕ=1.60.

The initial layer (thickness wet=30 μm) may for example be deposited on the PET film by bar coating or spin coating.

In a second step (step b) the initial layer deposited on the PET film is concentrated so that the colloidal particles arrange themselves in the matrix and form an intermediate photonic crystal layer on the PET film.

This concentration may comprise the evaporation of the solvent of the initial layer, for example by virtue of drying in a forced convection oven of the initial layer for 50 minutes at a temperature of 80° C. The thickness of the intermediate layer after evaporation of the solvent is about 12 μm.

In a third step (step e), the matrix of the intermediate layer on the plastic film is solidified in order to form the photonic crystal layer on the PET film.

This solidification is here carried out by polymerization under ultraviolet (UV) light of the polymer matrix. The UV dose (hydrogen lamp, polymerization wavelength=365 nm) generally used for a complete polymerization of the matrix is comprised between 500 and 2000 millijoules per centimeter squared (mJ/cm²).

In a fourth step (step d), the PET film is applied to the ophthalmic lens so as to secure the photonic crystal layer to the front main face of the substrate of the ophthalmic lens.

The PET film may be transferred to the substrate by lamination (thermoforming then transfer) by means of an adhesive on the front main face of the substrate of the ophthalmic lens, as described in documents FR 2883984 and FR 2918917.

In the examples 1 to 4 below, the plastic film is transferred to an ophthalmic lens including a plano substrate (main faces parallel) of the organic material MR8 of 2 mm thickness. The ophthalmic lens thus manufactured includes a single photonic crystal layer of thickness E on its front main face.

FIG. 5 shows spectral reflectance curves C1, C2 as a function of wavelength between 380 nm and 580 nm for:
curve C1: the PET film covered with the photonic crystal layer (see above); and
curve C2: solely an antireflection coating such as described in international patent application WO 2013/171434 (example 1).

Although both systems have transmittance values T_{m,B} in the blue that are comparable (about 75-80%) the selectivity with which phototoxic blue light is blocked with the PET covered with the photonic crystal layer may clearly be seen.

The low reflectivity of the photonic-crystal-comprising system (curve C1) outside of its reflection peak 11 prevents the residual color reflected by the front face from being too intense (low chroma).

This may also be seen from tables 1 and 2 below, in which:
comparative example 1 corresponds to example 1 of international patent application WO 2013/171434; and
comparative example 2 corresponds to example 3 of international patent application WO 2013/171434.

TABLE 1

| | | Hue | | | Transmission |
|---|---|---|---|---|---|
| | Thickness | angle | Yellowness | Chroma C | Tm, B (%) at |
| | E (μm) | (°) | index (YI) | at 15° | 0° |
| Example 1 | 6 | 304 | 8 | 15 | 74 |
| Example 2 | 12 | 304 | 15 | 23 | 62 |
| Example 3 | 20 | 305 | 21 | 25 | 54 |
| Comparative | — | 312 | 10 | 56 | 82 |
| example 1 | | | | | |
| Comparative | — | 310 | 22 | 85 | 62 |
| example 2 | | | | | |

TABLE 2

| | | Mean | Luminous | Luminous |
|---|---|---|---|---|
| | Thickness | reflectance | reflectance | transmittance |
| | E (μm) | Rm (%) | Rv (%) | Tv (%) |
| Example 1 | 6 | 5.9 | 4.5 | 90 |
| Example 2 | 12 | 6.2 | 4.5 | 89 |
| Example 3 | 20 | 6.1 | 4.4 | 88 |
| Comparative | — | 3.0 | 0.6 | 98 |
| example 1 | | | | |
| Comparative | — | 8.7 | 1.7 | 98 |
| example 2 | | | | |

It may be seen from table 1 that the chroma values C of the reflected light (values measured for an angle of incidence of 15° on the front main face of the substrate, under standard illuminant D65 and with a standard observer (angle of 10°)) of examples 1 to 3 corresponding to ophthalmic lenses according to the invention are much lower, lower than 30, than is the case for comparative examples 1 and 2 corresponding to mineral interference filters based on an alternation of oxide layers of low and high refractive indices and that only partially reflect phototoxic blue light. This is in particular true at comparable mean transmittance in the blue T_{m,B} (example 2 and comparative example 2: T_{m,B}=62%).

It may also been seen in these tables that the yellowness indices YI of the light transmitted by the ophthalmic lenses of the invention are lower than those of the comparative examples.

FIG. 6 shows curves C3, C4, C5, C6 of spectral transmittance T_{A} as a function of wavelength λ between 380 nm and 580 nm for the various ophthalmic lenses (examples 1, 2, 3 and 4, respectively) according to the invention with various total thicknesses E for the photonic crystal layer.

FIG. 6 in association with table 3 below shows that the yellowness index YI increases in value with thickness but also that the total thickness E of the photonic crystal layer allows performance with respect to how well phototoxic blue light is blocked to be controlled.

TABLE 3

| | Thickness | Yellowness | Transmission |
|---|---|---|---|
| | E (μm) | index (YI) | Tm, B (%) |
| Example 1 | 6 | 8 | 74 |
| Example 2 | 12 | 15 | 62 |
| Example 3 | 20 | 21 | 54 |
| Example 4 | 25 | 27 | 50 |

### 2) Examples 5 to 8—Implementation No. 2: Direct Deposition of the Photonic Crystal Layer on the Substrate

In examples 5 to 8 below, the photonic crystal layer is deposited directly on the substrate of the ophthalmic lens, this substrate here being an organic glass of the CR39 type (glass sold under the tradename ORMA® by ESSILOR).

More precisely, according to one particular embodiment, in a first step of the process (step a′), an initial layer of a solution is deposited on the front main face of the substrate of the ophthalmic lens, said solution containing:
a solvent taking the form of glycol acetate; and
a composition such as described in document EP 2586799 and containing:
an acrylate polymer matrix of refractive index nₘₐₜ=1.6; and
organic colloidal particles in suspension in the matrix with a volume fraction fᵥ=40%, the colloidal particles being of “core-shelf” type with a core made of acrylic resin of diameter D-t=160 nm and of refractive index n_{co}=1.49, and a shell made of polystyrene of thickness t=70 nm and of refractive index nₛₕ=1.60.

The initial layer (thickness wet=20 μm) may for example be deposited on the CR39 substrate by bar coating, spin coating or dip coating.

In a second step (step b′) the initial layer deposited on the substrate is concentrated so that the colloidal particles arrange themselves in the matrix and form the intermediate photonic crystal layer on the front main face of the substrate.

This concentration may comprise the evaporation of the solvent of the initial layer, for example by virtue of drying in a forced convection oven of the initial layer for 20 minutes at a temperature of 80° C. The thickness E of the intermediate layer after evaporation of the solvent is 6 or 10 μm depending on the examples (see below).

In a third step (step c′), the matrix of the intermediate layer is solidified in order to form the photonic crystal layer on the substrate.

This solidification is here carried out by polymerization under ultraviolet (UV) light of the polymer matrix. The UV dose (hydrogen lamp, polymerization wavelength=365 nm) generally used for a complete polymerization of the matrix is comprised between 500 and 2000 millijoules per centimeter squared (mJ/cm²).

Example 5 corresponds to the ophthalmic lens manufactured according to the above process and in which the thickness E of the intermediate layer after evaporation of the solvent is 6 μm.

In examples 6 to 8:
example 6 corresponds to the ophthalmic lens manufactured according to the above process with an anti-abrasion coating such as described in document EP 0614957 deposited on the photonic crystal layer;
example 7 corresponds to example 6 with an antireflection coating effective in the visible and UV such as described in document WO 2012/076714;
example 8 is identical to example 7 in its structure (photonic crystal layer/anti-abrasion coating/antireflection treatment) with a thickness E of the intermediate layer after evaporation of the solvent of 10 μm.

Comparative example 3 below for its part corresponds to the interference filter described in document WO 2013/171434 (example 1) deposited on a CR39 substrate. The various performance levels achieved with the examples 5 to 8 has been given in tables 4 and 5 and is compared to comparative example No. 3.

TABLE 4

| | | Hue | | | Transmission |
|---|---|---|---|---|---|
| | Thickness | angle | Yellowness | Chroma C | Tm, B (%) at |
| | E (μm) | (°) | index (YI) | at 15° | 0° |
| Example 5 | 6 | 304 | 6.1 | 10 | 77.9 |
| Example 6 | 6 | 297 | 10 | 11 | 73.5 |
| Example 7 | 6 | 279 | 11 | 12 | 75.2 |
| Example 8 | 10 | 289 | 16 | 19 | 63.1 |
| Comparative | — | 311 | — | 59 | 84.0 |
| example 3 | | | | | |

TABLE 5

| | | Mean | Luminous | Luminous |
|---|---|---|---|---|
| | Thickness | reflectance | reflectance | transmittance |
| | E (μm) | Rm (%) | Rv (%) | Tv (%) |
| Example 5 | 6 | 5.8 | 4.6 | 91.5 |
| Example 6 | 6 | 3.9 | 4.0 | 91.6 |
| Example 7 | 6 | 2.1 | 1.5 | 96.6 |
| Example 8 | 10 | 2.1 | 1.4 | 95.6 |
| Comparative | — | — | 0.5 | >98.2 |
| example 3 | | | | |

From these tables it may be seen that the chroma value C for the reflected light (values measured for an angle of incidence of 15° on the front main face of the substrate, under standard illuminant D65 and with a standard observer (angle of 10°)) is lower for ophthalmic lenses according to the invention (examples 5 to 8) than for the prior-art ophthalmic lens (comparative example 3).

The ophthalmic lenses of the invention therefore have a residual hue in reflection (chroma) that is less pronounced, and a yellowness in transmission that is less perceptible to the wearer.

In addition, the performance in terms of “hue”, i.e. the yellowness index YI and the mean transmittance in the blue T_{m,B} are essentially governed by the photonic crystal layer: the subsequent addition of the anti-abrasion coating or of the antireflection treatment modify this performance little.

Moreover, the values of mean reflectance Rₘ, visual reflectance Rᵥ, and visual transmittance Tᵥ are improved by the addition of the anti-reflection treatment.

### 3) Examples 9 to 11—Implementation No. 3: Direct Deposition of the Photonic Crystal Layer on the Substrate

In examples 9 to 11 below, the protocol of example 5 was reproduced, but a dye was added to the solution containing a solvent, the colloidal particles and a matrix before deposition on a substrate of CR390.

Table 6 describes the dyes used and their concentrations. The series Epolight is available from Epolin, Newark, N.J., USA. The series SDA is available from HW Sands, Jupiter, Fla., USA.

TABLE 6

| | Dye | Concentration |
|---|---|---|
| Example 9 | Epolight 5821 | 0.125% |
| Example 10 | Epolight 5397 | 0.125% |
| Example 11 | SDA 1422 | 0.125% |

The various performance levels achieved with examples 5 (without dye) and 9 to 11 (with dye) have been given in tables 7 and 8.

TABLE 7

| | | Hue | | | Transmission |
|---|---|---|---|---|---|
| | Thickness | angle | Yellowness | Chroma C | Tm, B (%) at |
| | E (μm) | (°) | index (YI) | at 15° | 0° |
| Example 5 | 6 | 304 | 6.1 | 10 | 77.9 |
| Example 9 | 6 | 304 | 4.7 | 9 | 73.9 |
| Example 10 | 6 | 303 | −8.2 | 7 | 75.5 |
| Example 11 | 6 | 301 | −5.5 | 11 | 77.8 |

TABLE 8

| | | Mean | Luminous | Luminous |
|---|---|---|---|---|
| | Thickness | reflectance | reflectance | transmittance |
| | E (μm) | Rm (%) | Rv (%) | Tv (%) |
| Example 5 | 6 | 5.8 | 4.6 | 91.5 |
| Example 9 | 6 | 5.6 | 4.5 | 85.6 |
| Example 10 | 6 | 5.7 | 4.7 | 80.2 |
| Example 11 | 6 | 5.6 | 4.6 | 84.2 |

Ophthalmic lenses containing a dye have similar properties to undyed ophthalmic lenses: they have transmittances in the blue that are unchanged (about 75% for a thickness of photonic crystals of 6 μm) and low or slightly negative yellowness indices: the transmitted light is perceived as being very slightly yellow, or even bluish or pinkish (for the negative values of the yellowness index). Lastly, the hue and chroma of the reflected light are unchanged, because they are governed solely by the nature of the photonic crystals.

The addition of antireflection coatings to the ophthalmic lenses of examples 5 and 9 to 11 would lead to a decrease in the values of Rₘ and Rᵥ.

The ophthalmic lenses according to the invention, which selectively filter phototoxic blue light comprised between 420 nm and 450 nm by means of the photonic crystal layer, allow easy industrial management of performance levels depending on the requirements.

In particular, the choice of the thickness and of the components of the photonic crystal layers allows products to be designed more simply. In addition, the use of a photonic crystal layer deposited on one of the main faces of the substrate allows the function of selective filtration of phototoxic blue light by this layer to be disassociated from the general antireflection function, which may be provided by a conventional interference filter of the type consisting of a stack of thin dielectric layers.

1.-14. (canceled)

15. An ophthalmic lens including:
a substrate having a front main face and a back main face; and
a photonic crystal layer at least partially covering one of said main faces of the substrate;
said ophthalmic lens having:
a curve (C1) of spectral reflectivity (R_{λ}) for an angle of incidence on said front main face comprised between 0° and 45° that comprises a reflectivity peak having a maximum reflectivity value (Rₚ) at a peak wavelength (λₚ) comprised between 420 and 450 nanometers; and
a chroma value (C) in reflection from said front main face with an angle of incidence comprised between 0° and 45° that is lower than 30.

16. The ophthalmic lens as claimed in claim 15, having, in transmission through said ophthalmic lens with an angle of incidence comprised between 0° and 45°, a yellowness index (YI) lower than 30.

17. The ophthalmic lens as claimed in claim 15, having, in transmission through said ophthalmic lens with an angle of incidence comprised between 0° and 45°, a yellowness index (YI) lower than 20.

18. The ophthalmic lens as claimed in claim 1, wherein said maximum reflectivity value (Rₚ) is higher than 15%.

19. The ophthalmic lens as claimed in claim 1, wherein said reflectivity peak has a full width at half maximum (FWHM) smaller than 80 nanometers.

20. The ophthalmic lens as claimed in claim 1, wherein said reflectivity peak has a full width at half maximum (FWHM) smaller than 50 nanometers.

21. The ophthalmic lens as claimed in claim 1, wherein said chroma value (C) is lower than 20.

22. The ophthalmic lens as claimed in claim 1, having, for an angle of incidence comprised between 0° and 45°, a mean transmittance in the blue (T_{m,B}), in a wavelength range extending from 420 to 450 nanometers, lower than 80%.

23. The ophthalmic lens as claimed in claim 1, having a mean luminous transmittance (Tᵥ) higher than 92%.

24. The ophthalmic lens as claimed in claim 1, having a mean luminous reflectance (Rᵥ) lower than 2.5%.

25. The ophthalmic lens as claimed in claim 1, wherein said photonic crystal layer is formed from a matrix and from colloidal particles arranged in said matrix.

26. The ophthalmic lens as claimed in claim 1, wherein said photonic crystal layer has a thickness (E) comprised between 1 and 40 microns.

27. The ophthalmic lens as claimed in claim 1, wherein said photonic crystal layer has a thickness (E) comprised between 3 and 30 microns.

28. The ophthalmic lens as claimed in claim 1, wherein said photonic crystal layer comprises a dye.

29. The ophthalmic lens as claimed in claim 1, wherein said photonic crystal layer has:
a curve of spectral reflectivity for an angle of incidence comprised between 0° and 45° that comprises a reflectivity peak having a maximum reflectivity value at a wavelength comprised between 420 and 450 nanometers; and
a chroma value in reflection from said layer with an angle of incidence comprised between 0° and 45° that is lower than 30.

30. A process for manufacturing an ophthalmic lens, including the following steps:
a) depositing on a plastic film an initial layer of a solution containing a solvent and a composition containing colloidal particles in suspension in a matrix;
b) at least partially evaporating the solvent from the initial layer deposited on said plastic film so that the colloidal particles arrange themselves in said matrix to form an intermediate photonic crystal layer on said plastic film;
c) solidifying the matrix of said intermediate layer on said plastic film in order to form a photonic crystal layer on said plastic film; and
d) applying said plastic film to said ophthalmic lens so as to secure said photonic crystal layer to at least one of the front and back main faces of a substrate of the ophthalmic lens;
wherein the composition implemented in step a) is such that the ophthalmic lens has
a curve of spectral reflectivity for an angle of incidence on said front main face comprised between 0° and 45° that comprises a reflectivity peak having a maximum reflectivity value at a peak wavelength comprised between 420 and 450 nanometers; and
a chroma value (C) in reflection from said front main face with an angle of incidence comprised between 0° and 45° that is lower than 30.

31. A process for manufacturing an ophthalmic lens, including the following steps:
a′) depositing an initial layer of a solution containing a solvent and a composition containing colloidal particles in suspension in a matrix on at least one of the front and back main faces of a substrate of the ophthalmic lens;
b′) at least partially evaporating the solvent from the initial layer deposited on said main face so that the colloidal particles arrange themselves in said matrix to form an intermediate photonic crystal layer; and
c′) solidifying the matrix of the intermediate layer;
wherein the composition implemented in step a′) is such that the ophthalmic lens has
a curve of spectral reflectivity for an angle of incidence on said front main face comprised between 0° and 45° that comprises a reflectivity peak having a maximum reflectivity value at a peak wavelength comprised between 420 and 450 nanometers; and
a chroma value (C) in reflection from said front main face with an angle of incidence comprised between 0° and 45° that is lower than 30.
